(19) United States
(12) Patent Application Publication
(10) Pub. No.: US 2012/0119032 A1
(43) Pub. Date: May 17, 2012

(54) SECOND HOSE WALL

(76) Inventors: ERIC BENASSI, St. Pierre Les Elbeuf (FR); Stephane Goujon, Les Damps (FR); Herve Onno, Quincampoix (FR)

(21) Appl. No.: 13/226,670

(22) Filed: Sep. 7, 2011

Related U.S. Application Data
(60) Provisional application No. 61/380,443, filed on Sep. 7, 2010.

(51) Int. Cl. B64D 37/00; B64D 37/20; B23P 11/00; F16L 11/10; F16L 11/20; B65B 3/04; B64D 37/16; B32B 37/14

(52) U.S. Cl. 244/135 R; 156/190; 138/137; 141/1; 29/428

(57) ABSTRACT

Embodiments of the present invention provide second wall hoses for use in a fuel system in order to ensure that, in the event of failure of the first internal hose, the second wall hose contains any leakage. Specific embodiments are designed for particular use on aircraft, where weight is sought to be kept as minimal as possible.

### CROSS REFERENCE TO RELATED APPLICATIONS

This application claims the benefit of U.S. Provisional Application Ser. No. 61/380,443, filed Sep. 7, 2010, titled “Second Wall Hose,” the entire contents of which are hereby incorporated by reference.

### FIELD OF THE INVENTION

Embodiments of the present invention relate generally to hoses for use as a second wall hose in a fuel system in order to ensure that, in the event of failure of the first hose, the second wall hose contains any leakage. Specific embodiments are designed for particular use on-board aircraft, where weight is sought to be kept to a minimum.

### BACKGROUND

Airborne vehicles use numerous hoses in order to transport fluids such as fuel into the vehicle. They also use such hoses to vent air, drain fuel, and so forth. These hoses must withstand certain pressure and temperature gradients, as well as be fuel-tight in the event of a crash (i.e., crash-worthy). A second wall hose may used to contain, enclose, or surround a primary internal hose, so that, in the event of a leak that may be incurred by the internal hose, the leaked fluid is maintained within the second wall hose. This can be particularly useful for fuel systems on board aircraft. In this instance, it is important to ensure that any leaked fuel is contained and drained appropriately.

Current second wall hoses for use on airborne vehicles are typically designed to be similar to the primary internal hose (or first wall hose) simply having a larger diameter so as to contain the first wall hose. Primary/first wall hoses for use on-board aircraft are typically designed to meet certain specifications for all types of aircraft, for example up to 55 psi and upwards. They are often heavy and expensive, made from a double layer of material and covered with a pressure resistant fabric or braid. As a consequence, using a traditional first wall internal hose as the internal hose as well as a larger diameter hose of a similar construction as the outer hose layer adds a good deal of weight to the system. Additionally, the second hoses are often over-designed for their primary use, which is to maintain leaks. Because the first wall internal hose is the hose that experiences the bulk of the pressure, the second wall hose does not necessarily need to be made to withstand those same pressures. Moreover, the second wall hose does not need to be impermeable to material (fluid or gas) the same way as the internal one. Numerous hoses described in several patents have a more complicated design compared to the present hose. A typical layer, called the barrier layer is used in the architecture of those hoses. This barrier layer brings an impermeability property to the hose (the transported fluid is protected against the external atmosphere/humidity). This requirement is not needed for the second wall hose described herein.

Additionally, air vent hoses (which may have a construction similar in some aspects to the second wall hose described) are designed so that they operate under 0.72 to 0.87 psi (pounds per square inch) max, while the second wall hoses described herein are designed and configured to withstand up to about 8 or 9 psi, and specifically about 8.7 psi. Air vent hoses are also not tight, in contrast to the hoses described herein. Moreover, air vent materials do not have electro static discharge, fungus and/or fireproof properties.

Because the second wall hoses currently in use are standardized hoses that are designed for a number of uses in a number of varying sized aircraft, they are stronger and heavier than needed for their intended use. This added weight adds unnecessary expense. It also adds to the manufacturing cost of the hose itself.

In other words, the companies who manufacture aeronautical hoses address the widest variety of markets, manufacturing hoses that comply with regulations setting the highest pressure resistance requirements. It is thus desirable to provide a second wall hose design that can be used to contain a first wall internal hose (and thus contain any potential leaks therefrom), that is lighter and less expensive to manufacture than those currently on the market. It is also desirable that the second wall hose design still be able to withstand appropriate temperature and pressure ranges for the specified vehicle.

One primary difference between prior art hoses and the hoses described herein is that the use of a barrier layer (or a ply) in prior fluid transport hoses is not present in the current second wall hose design. For example, a barrier layer of an impermeable material (such as a polyvinyl alcohol (PVOH) resin membrane, a polyamide layer (such as polyamide 6, polyethylene terephthalate (PET) between two sheets of polyvinylidene chloride, a metallic layer foil layer, such as one formed by vapor deposition, a metallic and plastic layer, a low permeable polymer layer or a metallic layer, along with other options) is often used to provide an impermeability property to the hose. In other words, these hoses provide an important barrier layer as required for use with a fluid transport hose. The presence of this layer is due to the primary use of those hoses, because in addition to being a “back-up” hose, they are also designed to be used as a primary hose. The fluid contained therein should not be contaminated by exterior components and exterior atmosphere should not be contaminated by gas which may be transported by those hoses. However, this property is not a requirement for a true second wall hose that it is only built for draining or leakage containment.

The design of the outer ply, which can be considered as the reinforcement layer, is also different between the current second wall hose and hoses described in the prior art. Indeed, internal pressures encountered by a second wall hose as compared to a fluid transport hose are not in the same level. Hoses built for transporting water or hydrocarbons under pressure (for example offshore drilling) need to have a reinforcing layer (such as one based on a metallic carcass, an aluminum alloy based layer, two textile plies (such as PET, PEN, aramid, PA, or so forth) applied with two different angles to prevent the hose from elongation and contraction when the hose is submitted to internal pressure). This structure strengthens the hose against internal and external pressure because the operating pressure for these types of hose can reach upwards of 7250 psi. Because of its primary designed-for use, the second wall hoses described herein do not need to have such a strong outer layer. Moreover, for the current second wall hoses, a steel coil is provided to take a reinforcing role, but to also help to keep the shape of the hose when it is bent or bending.

### BRIEF SUMMARY

Embodiments of the invention described herein thus provide second wall hoses with geometries and designs that are compliant with aeronautic requirements for use as a second wall hose, but that are lighter and less expensive to manufacture than current hoses that are used as the external hose. The second wall hoses are primarily used in aeronautic fuel transport, and function to capture and contain any leaks in the primary/first wall hose, as well as drain fuel back to the tank in the case of leakage, particularly in areas where a fire risk is identified. The second wall hose should be fuel resistant, fuel proof, fire resistant, and should keep its geometry constant in order to provide a sufficient free section (between the first wall internal hose and the second wall hose) that allows fuel to drain back into a tank. Fuel resistance or fuel proofness shall be maintained even in the event of harsh environment conditions or external aggressions such as abrasion, superficial puncture, elongation, and other extreme conditions.

### BRIEF DESCRIPTION OF THE DRAWINGS

FIG. 1 shows a schematic view of a second wall hose system according to various embodiments of the invention.

FIG. 2 shows a side cross-sectional view of a second wall hose.

FIG. 3 shows a detailed view of a portion of the cross-section of FIG. 2

FIG. 4 shows a detailed view of a specific embodiment of a second wall hose.

FIG. 5 shows a cross-sectional view of a specific embodiment of a second wall hose with a fitting positioned at an end thereof.

FIG. 6 shows a side perspective view of the hose of FIG. 5.

FIG. 7 shows a side perspective view of a second wall hose.

FIG. 8 shows a side perspective view of a second wall hose being labeled for use and in a curved position.

### DETAILED DESCRIPTION

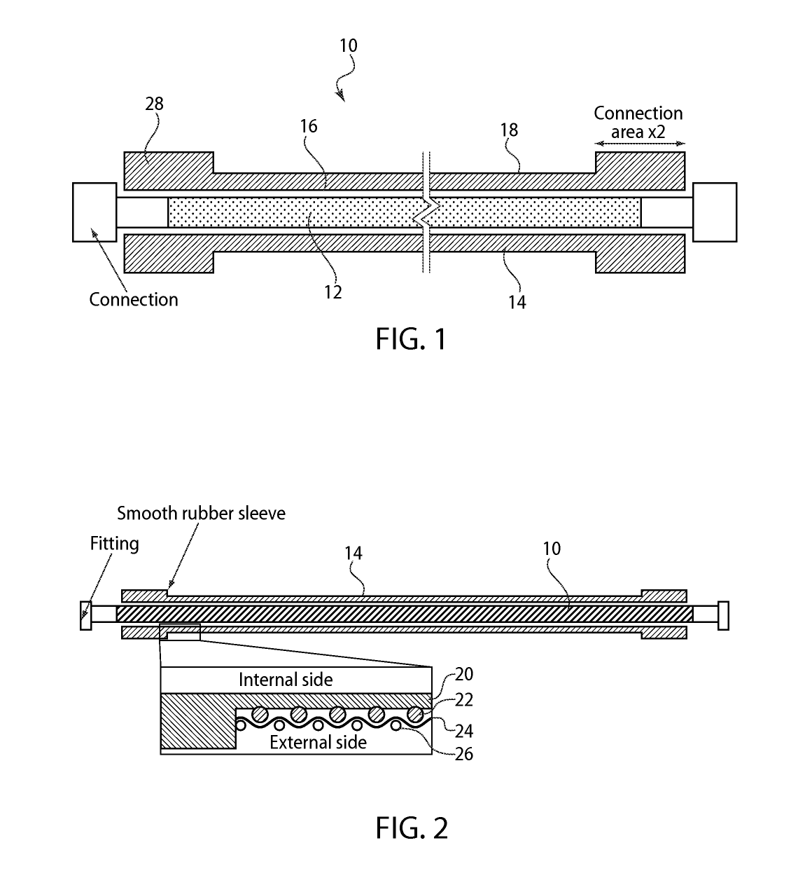

Embodiments of the present invention provide second wall hoses that have reduced weight and expense as compared to currently-available hoses. Particular embodiments are designed for use in airborne vehicles. The second wall hose system 10 includes an assembly of an internal hose 12 and a second wall hose 14, as shown in FIG. 1. The second wall hose 14 is used to assure security in case of leakage of the fuel pipes or internal hoses 10 situated inside an aircraft. For example, contrary to other aircraft hoses or air vent hoses with similar constructions (where the main use is continuous flow of fluid transport (oil, fuel, refrigerant fluid, air or so forth), the primary use of the second wall hose 14 is for drainage function or for leakage containment. Hoses 14 may be installed surrounding an internal hose 10 as shown, or they may be used as a stand-alone drain hose. The second wall hose has an internal side 16 and an external side 18. The hose 14 is comprised of a series of layers to add resistance, strength, flexibility, fuel proofness, dissipative properties, and resistance to external aggressions (such as fungus and/or mechanical stresses). For example, in one embodiment, the design can be considered as a two-part design: (1) an inner ply (made of rubber) and (2) an outer ply (made of a fabric and a helical wire). The fabric may be polyester and the wire may be a steel wire that creates a helical spring shape.

First, the internal side 16 of second wall hose 14 will face the internal hose 10 in use (if an internal hose is used). In a specific embodiment, internal side 16 is manufactured of at least one conductive layer of rubber material 20, rendering the hose fuel resistant and leak free. Rubber material 20 forms a tubular hose configuration. In a specific embodiment, the rubber material 20 may be a seamless rubber inner tube. Alternatively or additionally, the rubber material 20 may comprise two conductive layers of rubber material. The rubber material 20 used should be fuel compatible and electrically conductive. It is desirable that material 20 have static dissipative properties, because fuel loading can create friction, causing static build-up of charges, which could in turn cause the fuel to ignite.

In a particular embodiment, internal side 16 is formed of a material comprising a rubber elastomer (such as PVC/NBR or polyvinyl chloride/nitrile butadiene rubber or other thermoplastic or elastomeric material) combined with carbon and/or an anti-fungus growth component. An example of an appropriate material is manufactured and sold by Aerazur. Other potential materials for internal side 16 of hose include but are not limited to nitrile butadiene rubber (NBR), fluorinated elastomers (FKM), perfluoro-elastomers, tetrafluoro ethylene/propylene rubbers, vinylidene fluoride, fluorosilicone Rubber (FVMQ), ethylene-vinyl acetate (EVA), alkyl acrylate copolymer (ACM or any other elastomer which is fuel resistant.

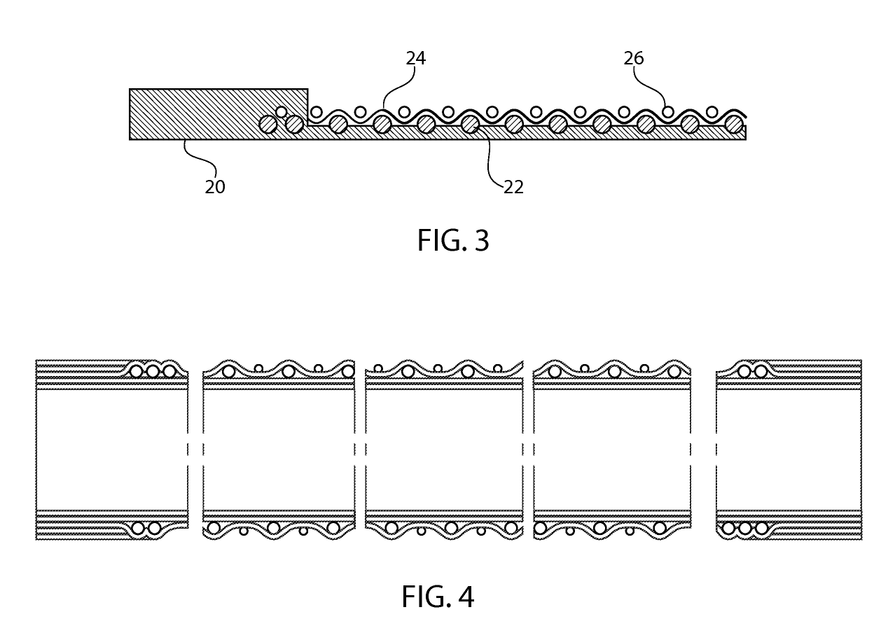

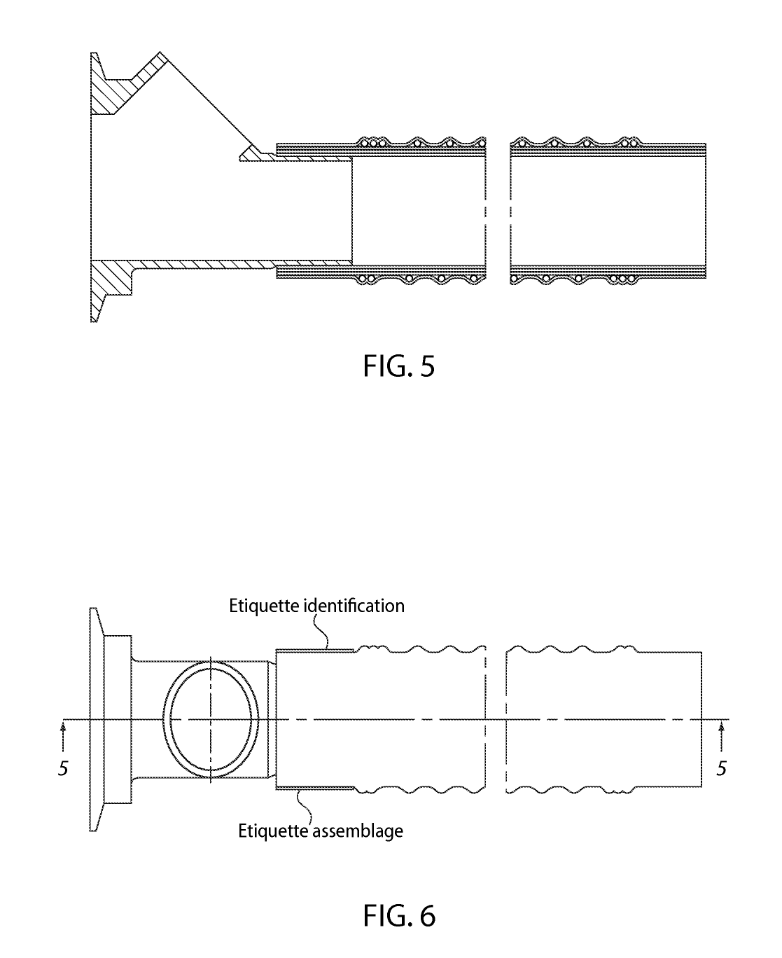

The next layer of hose 14 is a spring 22. Spring 22 is generally a metallic spring, and may be steel, a galvanized steel spring, or any other appropriate material, such as a steel alloy, aluminum, an aluminum alloy, titanium or a titanium alloy, or any other appropriate material that can create and form a coiled spring in order to provide structural support to hose. As shown in FIGS. 2 and 3, spring 22 is generally wound around rubber material 20 and helps provide support and structure to the second wall hose, such that hose 14 maintains its geometry whether or not the hose is bent. Spring 22 also helps make the hose more flexible. Furthermore, the metallic spring brings a protection against abrasion and mechanical aggression. It prevents the rubber layer from being crushed or otherwise damaged and so keeping the tightness of the hose. The lower the gap between the springs, the higher the protection against external aggression.

The next layer of hose 14 is a layer of fabric 24. In a specific embodiment, fabric 24 is layer of polyethylene terephthalate (PET) fabric. The PET fabric may be impregnated with chlorosulphonated-polyethylene (CSM) or Hypalon® to protect the hose and help render it non-flammable or at least fire resistant. Additionally or alternatively, the PET fabric may be coated with a rubber dissolution including a fungus resistant component. Thus, this fabric also helps increase fungal resistance of the hose 14. Other potential materials for fabric 24 include but are not limited to an aramid, a para-aramid, a meta aramid, a polyamide-imide, a polyester, or any other appropriate material.

The final layer of hose 14 is a rope or thread 26 which helps trap the fabric 24 between the spring coils 22. It also allows the hose 14 to have an even bending radius or otherwise maintains the radius of the hose when bent. In one embodiment, the fabric is a polyamide rope. Other potential materials for rope or thread 26 include but are not limited to a polyamide, a polyester, an aramid, a para-aramid, a meta aramid, a polyamide-imide, or any other appropriate material.

Stacking layers to manufacture hose 14 leads to a weight savings and a manufacturing cost reduction. It also helps provide strength to second wall hose without compromising its ability to withstand specified internal pressure. Hoses 14 generally only need to withstand a relatively small amount of internal pressure, as they are not the primary conducting hose for fluids. Accordingly, in one embodiment, hose 14 has an internal pressure resistance of at about 1 pound per square inch (psi). Additionally or alternatively, the hoses 14 may have a pressure service of up to 8.7 psi. It is, of course, possible to modify hose parameters, such as thickness and diameter in order to obtain a higher or lower pressure resistance, but it should be understood that increased parameters may add to the weight of hose, which may be undesirable.

Hose 14 may have varying inner and outer diameters. Inner diameters may range from about 15 mm to about 300 mm. For example, a size 22 hose may have an inner diameter of about 22 mm and an outer diameter (at the connection areas) of about 27 mm. A size 24 hose may have an inner diameter of about 24 mm and an outer diameter (out of the connection areas) of about 29 mm. An exemplary minimum dynamic radius at the inside of the bend may range from about 20 mm to about 45 mm. An exemplary maximum hose weight may range from 180 g/m to about 250 g/m. An exemplary maximum hose weight at the connection areas may range from about 20 g to about 30 g more particularly about 23 g and about 25 g. There are two connection areas but they need not always have the same configuration or otherwise be the same on both sides. Parameters for a very specific family of hoses are outlined in the below chart:

| | | Outer diameter | | Min dynamic | |
|---|---|---|---|---|---|
| | Inner | max (out of the | | bend radius | |
| | diameter | connection | Proof | at inside of | Hose |
| size | min. | areas) | pressure | bend | weight max |
| 22 | 22 mm | 27 mm | 1 psi | 25.4 mm | 188 g/m |
| 24 | 24 mm | 29 mm | 1 psi | 38.1 mm | 248 g/m |

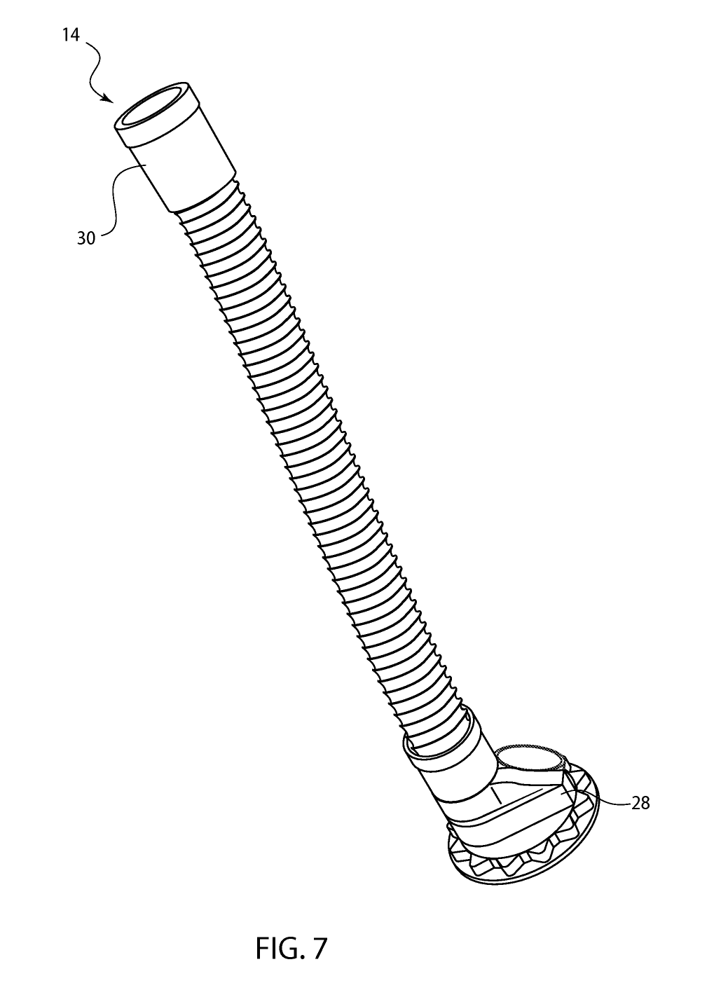

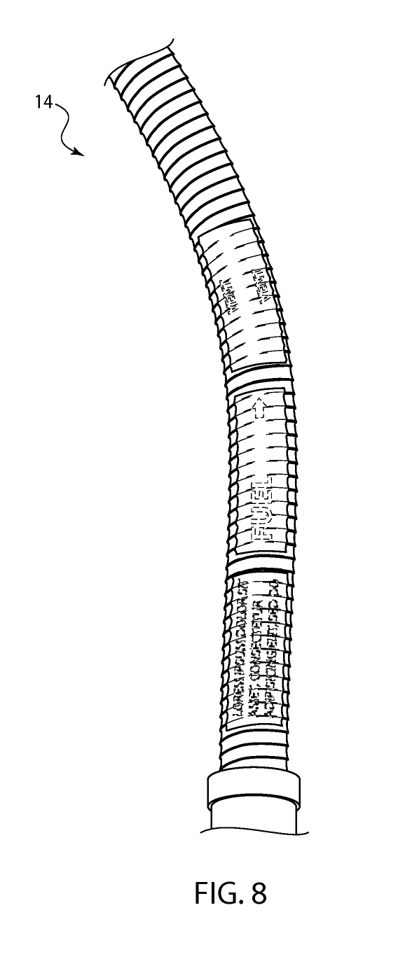

As shown in FIG. 1, second wall hose 14 and internal hose 12 may be attached, connected, coupled, hermetically attached, or sealed to one another via collars or fittings 28 in connection areas. As shown in FIG. 7, the end of hose 14 (or both ends of hose) may be wrapped with a rubber material 30, similar or the same as that used for the internal side 16 of hose 14. The rubber 30 may be wrapped around the end(s) of hose 14 much like one would wrap a tennis racquet. In some embodiments, this wrapping can be cured or heated to render it as smooth as possible. This allows second wall hose to be connected to a fitting 28 or some other component or structural element, providing the ability to use second wall hoses 14 for gravity fill, pressure fill, transfer between tanks, engine feeding, drainage, venting, or any other appropriate use on-board an aircraft vehicle. Hose may also be used to conduct any type of fluid, such as delivering or draining fuel or venting air and fuel vapors.

Specifically, the internal hose 12 may be connected to the desired equipment, and because the second wall hose 14 provides a wider, larger envelope, it is positioned to enclose or contain the internal wall hose. An end of second wall hose 14 may be secured or clamped into the appropriate securement area on the equipment.

Hoses 14 may have an operating temperature range between about −45° C. to about 90° C. (at operational temperatures) and about −55° C. to about 90° C. (at ground temperatures). This allows them to be used in extreme temperatures without failure.

Hoses 14 may be manufactured by winding or stacking the materials around a mandrel. For example, in a specific embodiment, the rubber material 20 may be wound around a mandrel, and then a pre-polymerization step may be conducted in order to pre-cure the rubber. A metallic component may then be wound around the rubber portion to form spring coils. A PET fabric is then wrapped around this configuration, and a polyamid thread or rope is wound between the metallic component. The entire configuration may be cured in order to form a second wall hose 14. Hose has the appearance of being convoluted and may be referred to as such, but the “convolutions” are provided by spring 22. It should be understood that other manufacturing methods are possible and considered within the scope of this invention.

Changes and modifications, additions and deletions may be made to the structures and methods recited above and shown in the drawings without departing from the scope or spirit of the invention and the following claims.

What is claimed is:

1. A second wall hose for an airborne vehicle, comprising:
an internal layer of rubber material comprising a rubber elastomer with a carbon component forming a tubular hose configuration;
a spring positioned around the tubular hose configuration;
a layer of fabric around the metallic spring; and
a polyamide thread around the layer of fabric.

2. The second wall hose of claim 1, wherein the polyamid thread traps the layer of fabric between metallic spring coils.

3. The second wall hose of claim 1, wherein the tubular hose configuration has an internal diameter of about 15 mm to about 300 mm.

4. The second wall hose of claim 1, wherein the layer of fabric comprises a polyethylene terephthalate fabric coated with a fireproof dissolution and a fungus resistant rubber dissolution.

5. The second wall hose of claim 1, wherein the spring comprises a metallic spring.

6. The second wall hose of claim 1, further comprising a fitting positioned at one or both ends of the hose.

7. The second wall hose of claim 1, where in the internal layer of rubber further comprises a fungus resistant component.

8. The second wall hose of claim 1, wherein the hose is configured to withstand an internal pressure of about 8-9 psi.

9. An aircraft hose system, comprising
(a) a second wall hose according to claim 1,
(b) an internal hose configured to be positioned within the second wall hose.

10. The aircraft hose system of claim 9, further comprising a fitting configured to secure the aircraft hose system to an aircraft fuel tank configured to deliver fuel through the aircraft hose system, drain fuel, or vent aircraft tanks.

11. A method of providing fuel to an aircraft engine, comprising:
(a) providing a second wall hose according to claim 1;
(b) providing an internal wall hose positioned within the second wall hose, in order to provide an aircraft hose system;
(c) connecting a fitting of the aircraft hose system to another hose, a tank, a vent hole, a pass wall, or fuel system hardware equipment; and
(d) conducting fluid through the aircraft hose system.

12. The method of claim 11, wherein the conducting fluid comprises delivering or draining fuel or venting air or fuel vapors.

13. A method of manufacturing a second wall hose for use on board an aircraft, comprising:
(a) providing a rubber material comprising a rubber elastomer with a carbon component and a fungus resistant component;
(b) wrapping the rubber material around a mandrel;
(b) wrapping a metallic spring around the rubber material;
(c) wrapping a layer of polyethylene terephthalate fabric around the metallic spring;
(d) wrapping a polyamide thread around the layer of polyethylene terephthalate fabric;
(e) curing all components in order to provide a second wall hose.

14. The method of claim 13, further comprising wrapping rubber material around an end of the second wall hose.

15. The method of claim 13, further comprising securing a fitting to an end of the second wall hose.
